(19) United States
(12) Patent Application Publication
(10) Pub. No.: US 2013/0264325 A1
(43) Pub. Date: Oct. 10, 2013

(54) REMOTE HIGH VOLTAGE SWITCH FOR CONTROLLING A HIGH VOLTAGE HEATER LOCATED INSIDE A VEHICLE CABIN

(71) Applicants: MARK D. NEMESH, TROY, MI (US); WISSAM IBRI, MACOMB, MI (US)

(72) Inventors: MARK D. NEMESH, TROY, MI (US); WISSAM IBRI, MACOMB, MI (US)

(73) Assignee: GM GLOBAL TECHNOLOGY OPERATIONS LLC, DETROIT, MI (US)

(21) Appl. No.: 13/439,627

(22) Filed: Apr. 4, 2012

(51) Int. Cl. B60L 1/02

(52) U.S. Cl. 219/202

(57) ABSTRACT

An electronic circuit is provided for electrically isolating a heater in a motor vehicle upon detection of a crash event. The circuit includes a high voltage convection heater mounted in a passenger compartment of the vehicle, a controller mounted in an under hood compartment of the vehicle, a battery, and a collision sensor configured to apply a crash signal to the controller upon detection of a crash event. The controller is configured to selectively electrically isolate the heater from the battery in response to the crash signal. The vehicle also includes a fresh air plenum on which the controller is mounted.

### TECHNICAL FIELD

The technical field generally relates to high voltage devices used in motor vehicles, and more particularly relates to a high voltage device controllers.

### BACKGROUND

Increasingly, passenger vehicles use electric motors in lieu of internal combustion engines. For example, a vehicle may include an alternating current (AC) motor that is coupled to an inverter. The inverter converts direct current (DC) received from a power source (e.g., a battery) into alternating current that can be used by the electric motor. In contrast to an internal combustion engine, an electric motor does not yield a significant amount of thermal energy; hence, contemporary electric vehicles are equipped with an auxiliary heating device, such as a high voltage electric convection heater, to generate cabin heat for windshield clearing and passenger comfort.

However, the use of an auxiliary heater under the hood has certain disadvantages. For example, in cold environments, heating incoming (cold) air from the vehicle's fresh air plenum under the hood is thermodynamically inefficient; that is, some of the thermal energy produced by the heater is lost in the cold under-hood environment through convection, conduction, and bulk flow. These energy losses deplete the vehicle's battery pack and represent power that is unavailable for vehicle propulsion.

A collision can result in uncontrolled and unpredictable movement and deformation of structure within the cabin. To avoid creating an unintended electrically conductive path within the passenger compartment resulting from a collision, presently known vehicle designs do not place the heater or the high voltage bus in the cabin.

Accordingly, it is desirable to provide a thermodynamically efficient layout for a high voltage heater in a vehicle which mitigates the risk of creating an unintended high voltage electrical path within the cabin in a crash event. Furthermore, other desirable features and characteristics of the present invention will become apparent from the subsequent detailed description and the appended claims, taken in conjunction with the accompanying drawings and the foregoing technical field and background.

### SUMMARY

In accordance with an embodiment, an electronic circuit is provided for electrically isolating a heater in an electric vehicle. The circuit includes a high voltage convection heater mounted in a passenger compartment of the vehicle, a controller mounted in an under hood compartment of the vehicle, a battery, and a collision sensor configured to apply a crash signal to the controller upon detection of a crash event. The controller is configured to selectively electrically isolate the heater from the battery in response to the crash signal. The vehicle also includes a fresh air plenum on which the controller is mounted.

In accordance with a further embodiment, a method is provided for immediately terminating high voltage power to a convection heater disposed inside the cabin of a motor vehicle upon detection of a crash event. The method includes connecting, via a connecting cable, the heater to a high voltage bus disposed in an under hood compartment, wherein the cabin and the under hood compartment are separated by a dash bulkhead having an opening through which the connecting cable extends.

In yet a further embodiment, a method is provided for placing a high voltage fan behind a radiator located in the under hood compartment connecting a control switch in series between the high voltage bus and the high voltage fan, and electrically isolating the fan from the high voltage bus in a crash event.

### DESCRIPTION OF THE DRAWINGS

The subject matter will hereinafter be described in conjunction with the following drawing figures, wherein like numerals denote like elements, and;

FIG. 1 is a schematic illustration of a vehicle suitable for using exemplary embodiments of the present disclosure;

FIG. 2 is a schematic illustration of an exemplary embodiment of a cabin heater system and remote high voltage controller according to the present disclosure;

FIG. 3 is a schematic wiring circuit showing a battery pack, high voltage bus, crash detector, cabin heater, and high voltage controller according to the present disclosure;

FIG. 4 is a flow diagram setting forth the steps for terminating high voltage power to the cabin heater shown in FIGS. 2 and 3;

FIG. 5 is a schematic illustration of a high voltage radiator fan system in accordance with the prior art; and

FIG. 6 is a schematic illustration of an exemplary embodiment of a high voltage radiator fan system and high voltage controller according to the present disclosure.

### DETAILED DESCRIPTION

The following detailed description is merely exemplary in nature and is not intended to limit the subject matter of the disclosure or its uses. Furthermore, there is no intention to be bound by any expressed or implied theory presented in the preceding technical field, background, brief summary or the following detailed description.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language.

Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

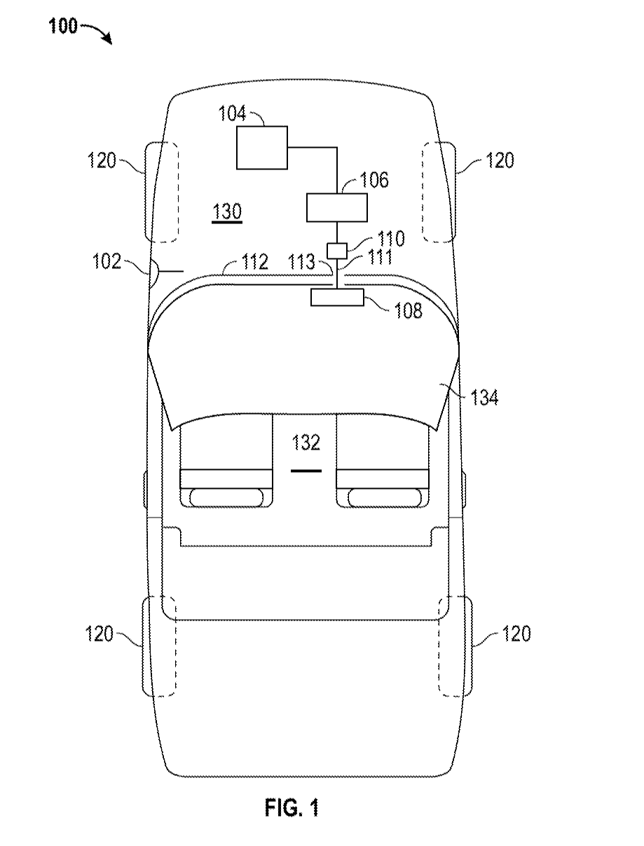

Finally, for the sake of brevity, conventional techniques and components related to vehicle electrical and mechanical parts and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention. It should also be understood that FIGS. 1-6 are merely illustrative and may not be drawn to scale.

FIG. 1 is a simplified schematic representation of an embodiment of a vehicle 100 suitable for use with exemplary embodiments of the present disclosure. Although the cabin heater system of the present disclosure is described in the context of an electric vehicle, the techniques and concepts described herein are also applicable to a hybrid or any other type of vehicle. The vehicle 100 may be any one of a number of different types of vehicles, such as, for example, a sedan, a wagon, a truck, or a sport utility vehicle (SUV), and may be two-wheel drive (2WD), four-wheel drive (4WD), or all-wheel drive (AWD).

The vehicle 100 may also incorporate any one of, or combination of, a number of different types of engines, such as, for example, a gasoline or diesel fueled combustion engine, a flex fuel vehicle (FFV) engine (i.e., using a mixture of gasoline and alcohol), a gaseous compound (e.g., hydrogen and/or natural gas) fueled engine in addition to an electric motor.

Electric and hybrid electric vehicles often use sources of high voltage such as battery packs or fuel cells that deliver direct current (DC) to drive vehicle motors, electric traction systems (ETS), and other vehicle systems. Power switches used in high voltage applications, such as integrated gate bipolar transistor (IGBT) modules and power diodes may generate considerable heat. Because the performance characteristics of many electronic components can be affected by high temperatures, power switches generally include a cooling system to dissipate heat. Such a cooling system typically includes a heat sink having a relatively large thermal mass, and may be coupled to the fresh air plenum of the vehicle, as described in greater detail below.

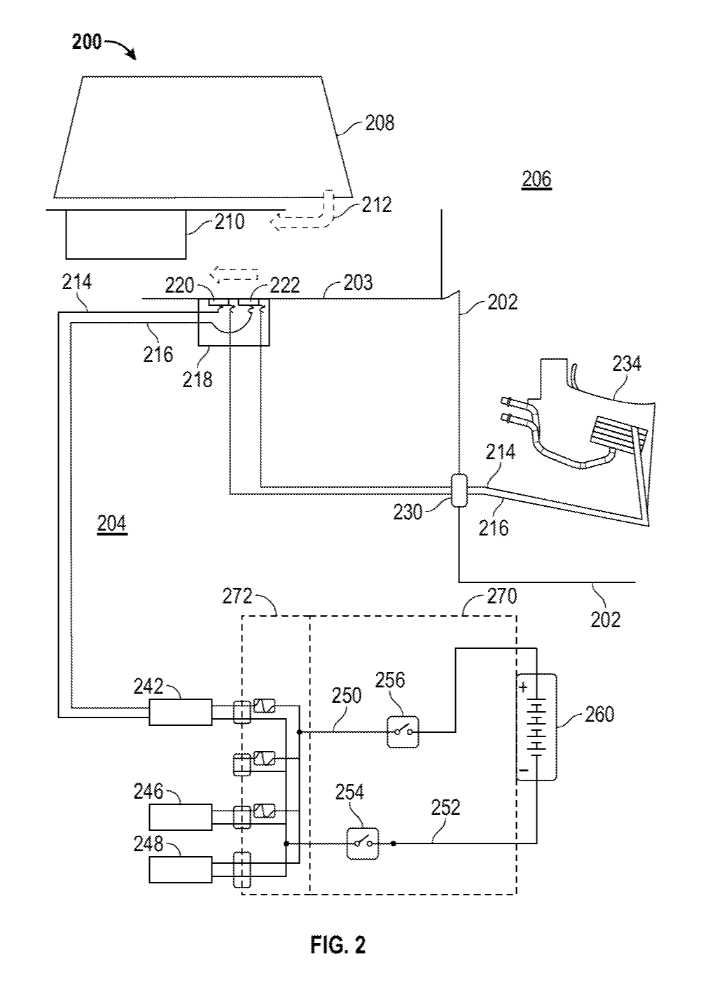

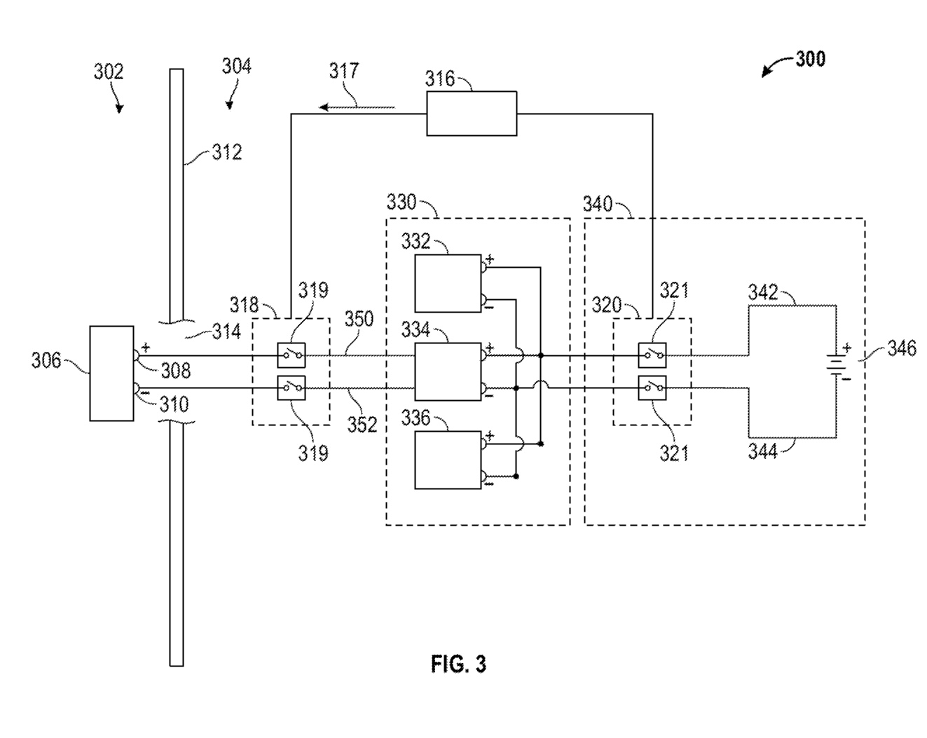

The illustrated embodiment of the electric vehicle 100 includes, without limitation: a plug-in charging port 102 coupled to an energy storage system 104; a control module coupled to a generator for charging the energy storage system including a battery 104; and a high voltage bus 106 for providing high voltage power to various devices and components as described below in conjunction with FIGS. 2 and 3. Automotive electrical distribution systems typically include a wiring harness for supplying low voltage power to low voltage devices (such as light bulbs, indicator lights, and the like), and a high voltage bus for supplying high voltage power to high voltage components, such as cabin heaters and cooling fans. The vehicle powertrain (not shown) includes an electric motor and a transmission for driving wheels 120 to propel the vehicle 100.

With continued reference to FIG. 1, vehicle 100 includes a passenger compartment 132 and an under hood compartment 130 separated by a bulkhead 112 upon which a windshield 134 is mounted. A high voltage device such as, for example, a cabin heater 108, is disposed inside the cabin 132. Battery 104 supplies electric power to heater 108 through a high voltage bus 106. A remote controller 110 is connected in series between battery 104 and heater 108 and, more particularly, between high voltage bus 106 and heater 108. A conduit 111, such as an electric wire or wires, passes through an opening 113 in bulkhead 112 between controller 106 and heater 108.

FIG. 2 is a schematic illustration of an exemplary embodiment of a system 200 for selectively electrically isolating a high voltage component disposed inside the passenger cabin of a vehicle according to the present disclosure. In the illustrated embodiment, the high voltage component is a convection heater, although any component may be selectively electrically isolated in accordance with the teachings of the present disclosure.

System 200 includes a passenger cabin 206 (the vehicle interior) and an under hood compartment 204 separated by a dashboard and/or bulkhead 202. System 200 further includes a battery or battery pack 260, a high voltage bus 272, and a contactor module 270 having a pair of contactor switches 254 and 256. In an embodiment, switches 254 and 256 are IGBTs; alternatively, the switches may be mechanical contactors. High voltage bus 272 supplies high voltage power to various devices and components such as, for example, an auxiliary power module (APM) 242, an air conditioning compressor module (ACCM) 246, a transmission power inverter module (TPIM) 248, and the like.

In the event of a collision, one or more crash sensors (not shown in FIG. 2; see FIG. 3), such as an accelerometer, typically cause the deployment of one or more airbags and open switches 254 and 256, thereby terminating power to high voltage bus 272 and, hence to high voltage devices 242-248. However, the capacitance associated with these devices can result in a decay on the order of up to five seconds or more. For this reason, high voltage devices and, indeed, the high voltage bus, are preferably mounted under the hood as opposed to inside the passenger compartment.

With continued reference to FIG. 2, system 200 further includes a windshield 208 mounted on the bulkhead/dashboard 202. A leaf screen 212 is disposed on the exterior of the vehicle proximate the base of the windshield, through which fresh air flows into an HVAC (heating ventilation and air conditioning) inlet 210 and through the vehicle's fresh air plenum 203. A cabin heater 234, for example, a convection heater, is disposed in cabin 206. A positive polarity supply line (wire) 214 and a negative polarity supply line 216 provide high voltage power to heater 234 directly from high voltage bus 272 or via a device connected to the bus, such as APM 242. Respective wires 214 and 216 may be conveniently passed through an opening 230 formed in bulkhead 202.

To minimize the risk of passenger exposure to high voltage potential in a crash event, a controller 218, having respective switches 220 and 222, is connected in series between high voltage bus 272 and heater 234. When a collision is detected, controller 218 terminates power to heater 234, for example, by opening switches 220 and 222 and thereby electrically isolating positive and negative polarity lines 214 and 216 from bus 272. As stated above, contactors 254 and 256 are configured to isolate battery 260 from bus 272 when a crash event is detected. However, it may take up to five seconds or more to deplete the high voltage potential from bus 272 and the various devices associated therewith due to the high capacitance of these components.

Therefore, incorporating an additional, remote controller 218 “downstream” from bus 272 and “upstream” of the heater, heater 234 may be immediately isolated from the then currently decaying high voltage potential associated with bus 272 and its associated components immediately following a crash event. In this way, the high voltage potential associated with heater 234 may be depleted nearly instantaneously, e.g., on the order of 50-500 milliseconds (ms) in response to a crash event or airbag deployment. This allows heater 234 to be safely disposed in cabin 206 and thereby enhance the thermodynamic efficiency of this placement vis-à-vis disposing heater 234 in the cold air environment under the hood.

Referring now to FIG. 3, a schematic diagram of an electronic circuit illustrates an exemplary wiring configuration for a high voltage system 300 including a high voltage heater 306 and a remote high voltage controller 318 according to the present disclosure. The topology illustrated in FIG. 3 shows heater 306 disposed in a passenger cabin compartment 302, separated from an under hood compartment 304 by a partition 312 such as a bulkhead. Heater 306 includes a positive polarity terminal 308 and a negative polarity terminal 310. First and second wires 350 and 352 supply power to heater 306 from a battery pack 340 via a high voltage bus 330. Battery pack 340 includes a battery 346 and a first switch 320. Bus 330 may also provide high voltage power to various additional high voltage devices 332, 334, and 336 such as, for example, APM 242, ACCM 246, TPIM 248, and the like.

First switch 320 includes respective contactors 321 and is connected in series between battery 346 and bus 330. A second switch (controller) 318 includes respective switches, contactors, or IGBTs 319, and is connected in series between heater 306 and high voltage bus 330. A crash sensor 316 is configured to send a crash signal 317 to remote controller 318 upon detection of a crash event. Upon receipt of crash signal 317, controller 318 immediately electrically isolates heater 306 from high voltage bus 330. Additionally, sensor 316 may be configured to send a crash signal to switch 320 to isolate battery 346 from high voltage bus 330 during a collision.

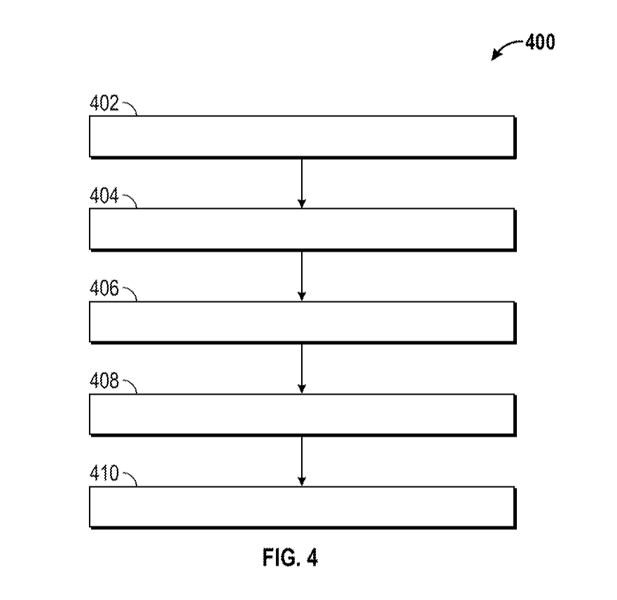

Referring now to FIG. 4, a flow diagram sets forth a method 400 for terminating high voltage power to a convection heater disposed inside the cabin of a motor vehicle upon detection of a crash event. For illustrative purposes, the following description of the method of FIG. 4 may refer to elements mentioned above in connection with FIGS. 1-3. It should also be appreciated that the method of FIG. 4 may include any number of additional or alternative tasks and that the method may be incorporated into a more comprehensive procedure or process having additional functionality not described in detail herein. Moreover, one or more of the tasks shown in FIG. 4 could be performed in a different order than that shown as long as the intended overall functionality remains intact.

The method 400 involves connecting (task 402), via a connecting cable, the heater to a high voltage bus disposed in an under hood compartment of a vehicle, wherein the cabin and the under hood compartment are separated by a bulkhead having an opening through which the connecting cable extends. Method 400 includes interposing, configuring, placing, or installing (task 404) a control switch in series between the heater and the high voltage bus, and sending (task 406) a signal to the controller from a crash detector upon detection of a crash event.

Method 400 further involves actuating (task 408) controller 318 (FIG. 3), and electrically isolating (task 410) the heater from the high voltage bus upon receipt of the crash signal by the controller.

Accordingly, a high voltage heater is placed in the passenger cabin of a vehicle, and a remote high voltage controller is placed on the other side of a partition to thereby protect the passenger from contacting the high voltage bus in the event of a collision. The remote controller of the present disclosure may include one or more IGBTs and may be mounted to the fresh air plenum under the hood to provide a heat sink, or the remote controller may be convectively cooled (e.g., via vehicle underhood or underbody airflow), or the remote controller may be conductively cooled (e.g., via mounting to either vehicle structure or mounting to any other vehicle subsystem). This arrangement (topology) promotes thermodynamic efficiency by insulating the heater from the cold air under hood environment, and facilitates immediate electrical isolation of the heater from the high voltage bus upon airbag deployment.

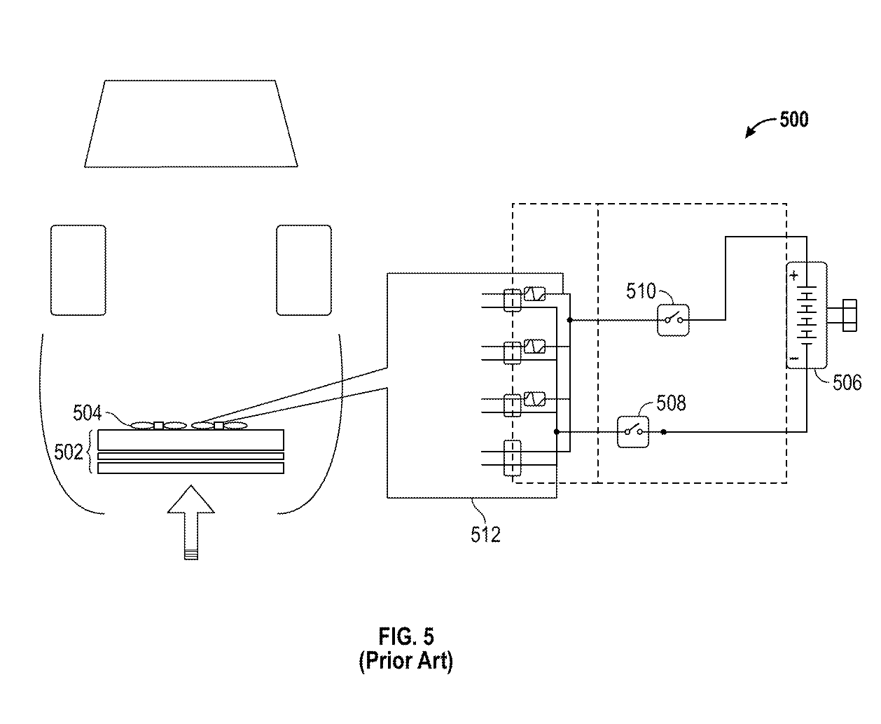

Referring now to FIG. 5, an alternate application embodied by the present disclosure involves selectively electrically isolating a high voltage fan from the high voltage bus in a crash event. As is known in the art, a cooling system 500 may be used in a motor vehicle which includes an internal combustion or other type of engine which requires cooling. More particularly, a high voltage cooling fan 504 is disposed behind a radiator assembly 502.

High voltage fan 504 is powered by a battery 506 via a high voltage bus 512. A pair of switches 508, 510 are configured to terminate power to the high voltage bus upon detection of a crash event. However, as discussed above, due to the decay time associated with high voltage bus 512, fan 504 can remain in a high voltage state for milliseconds or even seconds after a collision, posing a potential risk of electric shock to passengers.

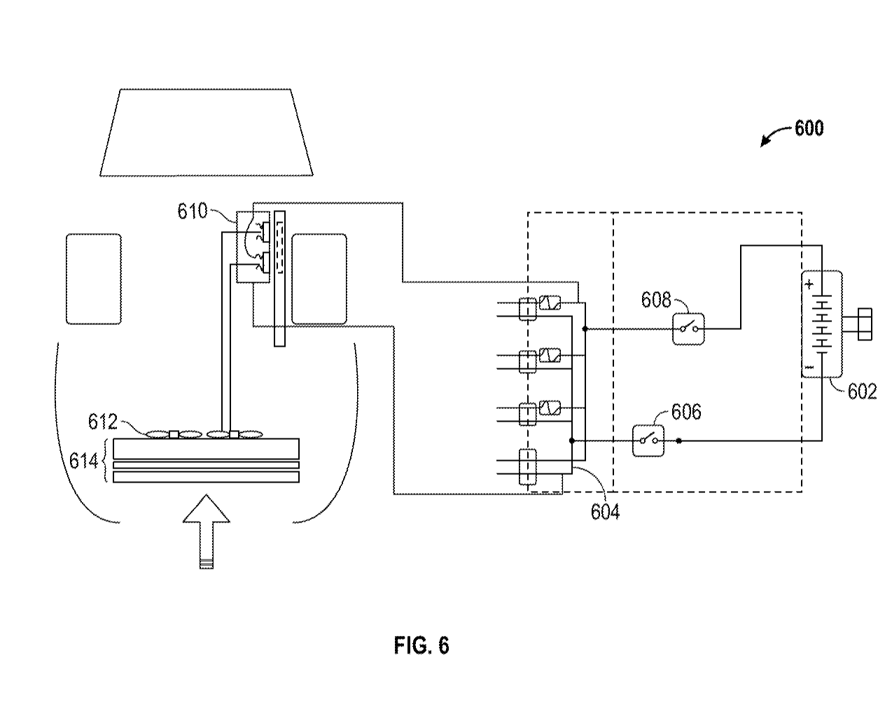

Referring now to FIG. 6, an improved cooling fan system 600 in accordance with the present disclosure includes a high voltage fan 612 disposed in the under hood compartment behind a radiator assembly 614. A battery 602 supplies power to fan 612 via a high voltage bus 604. Respective switches 606 and 608 are connected in series between battery 602 and bus 604, and are configured to electrically isolate bus 604 from battery 602 upon detection of a crash event.

With continued reference to FIG. 6, a controller 610 is connected in series between bus 604 and fan 612. Controller 610 may comprise IGBTs or any other structure for electrically isolating fan 612 from high voltage bus 604 when a crash event is detected. The remote controller 601 of the present disclosure may include one or more IGBTs and may be mounted to the fresh air plenum under the hood to provide a heat sink, or the remote controller 610 may be conveniently cooled (e.g., via vehicle underhood or underbody airflow), or the remote controller 610 may be conductively cooled (e.g., via mounting to either vehicle structure or mounting to any other vehicle subsystem).

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing summary and detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. A cabin heater system for use in a motor vehicle of the type having a passenger cabin and an under hood compartment separated by a bulkhead, the cabin heater system comprising:
a high voltage heater disposed in said passenger cabin;
a vehicle battery configured to supply power to said high voltage heater through a high voltage bus; and
a switch disposed in said under hood compartment;
wherein said switch is configured to selectively isolate said high voltage heater from said battery and said high voltage bus.

2. The cabin heater system of claim 1, further comprising at least one additional high voltage device connected to said high voltage bus, wherein said switch is configured to selectively isolate said heater from said vehicle battery, said high voltage bus, and said additional high voltage device.

3. The cabin heater system of claim 2, wherein said high voltage heater is a convection heater.

4. The cabin heater system of claim 2, wherein said additional high voltage device comprises one of: a coolant heater; a transmission power inverter; and a refrigerant compressor.

5. The cabin heater system of claim 2, wherein said high voltage heater comprises a heater power connector, and said switch is connected in series between said heater power connector and said high voltage bus.

6. The cabin heater system of claim 5, wherein said high voltage bus comprises a positive bus terminal and a negative bus terminal, said heater power connector comprises a positive heater terminal connected via said switch to said positive bus terminal and a negative heater terminal connected via said switch to said negative bus terminal.

7. The cabin heater system of claim 5, further comprising a crash sensor module configured to output a crash signal upon detection of a crash event, and wherein said switch is configured to electrically isolate said heater from said high voltage bus in response to said crash signal.

8. The cabin heater system of claim 7, wherein said switch comprises an integrated gate bipolar transistor (IGBT).

9. The cabin heater system of claim 8, further comprising an isolation contactor disposed in series between said vehicle battery and said high voltage bus.

10. The cabin heater system of claim 9, wherein said isolation contactor comprises an IGBT, and further wherein said isolation contactor is configured to electrically isolate said vehicle battery from said high voltage bus upon receipt of said crash signal from said crash sensor module.

11. The cabin heater system of claim 7, wherein said motor vehicle is at least one of: an electric vehicle (EV); a plug-in hybrid electric vehicle (PHEV); an extended range electric vehicle (EREV); and a vehicle equipped with an internal combustion engine.

12. The cabin heater system of claim 11, wherein said motor vehicle further includes an airbag and said airbag is deployed in response to the detection of said crash event.

13. The cabin heater system of claim 12, wherein said crash sensor module comprises an accelerometer.

14. The cabin heater system of claim 1, wherein said motor vehicle further includes a fresh air plenum and said switch is attached to said fresh air plenum.

15. The cabin heater system of claim 2, wherein said bulkhead comprises an opening, and said system further comprises an electrically conductive conduit extending through said opening and connecting said switch and said heater.

16. An electronic circuit for electrically isolating a heater in an electric vehicle, comprising:
a high voltage convection heater mounted in a passenger compartment of said electric vehicle;
a controller mounted in an under hood compartment of said electric vehicle;
a battery; and
a collision sensor configured to apply a crash signal to said controller upon detection of a crash event;
wherein said controller is configured to selectively electrically isolate said heater from said battery in response to said crash signal.

17. The circuit of claim 16, wherein said vehicle comprises a fresh air plenum on which said controller is mounted.

18. The circuit of claim 16, further comprising a high voltage bus in said under hood compartment and a contactor switch connected in series between said battery and said high voltage bus, wherein said controller is connected in series between said high voltage bus and said heater.

19. A method for immediately terminating high voltage power to a convection heater disposed inside a cabin of a motor vehicle upon detection of a crash event, comprising:
connecting, via a connecting cable, said convection heater to a high voltage bus disposed in an under hood compartment of said motor vehicle, wherein said cabin and said under hood compartment are separated by a dash bulkhead having an opening through which said connecting cable extends;
interposing a control switch in series between said convection heater and said high voltage bus;
sending a signal to said control switch from a crash detector upon detection of said crash event; and
electrically isolating said convection heater from said high voltage bus upon receipt of said signal by said controller.

20. The method of claim 19, wherein said controller comprises a positive polarity IGBT and a negative polarity IGBT, and wherein electrically isolating comprises opening said IGBTs.

21. The method of claim 20, further comprising selectively electrically isolating a high voltage cooling fan from the high voltage bus in a crash event.

22. The method of claim 21, wherein said controller comprises a positive polarity IGBT and a negative polarity IGBT, and wherein electrically isolating comprises opening said positive and negative polarity IGBTs.

23. The method of claim 22, wherein said controller is cooled by at least one of:
mounting said controller to a fresh air plenum in said under hood compartment;
mounting said controller in the path of underhood or underbody airflow; and
mounting said controller to a vehicle structure which functions as a heat sink.
